(19) United States
(12) Patent Application Publication
(10) Pub. No.: US 2016/0308358 A1
(43) Pub. Date: Oct. 20, 2016

(54) Light System with Energy Management Function and Control Method Thereof

(71) Applicant: CHUNG YUAN CHRISTIAN UNIVERSITY, Tao-Yuan (TW)

(72) Inventors: Wu-Yang Sean, Tao-Yuan (TW); Yi-Hsien Chiang, Tao-Yuan (TW)

(21) Appl. No.: 14/740,866

(22) Filed: Jun. 16, 2015

(30) Foreign Application Priority Data
Apr. 17, 2015 (TW) 104112381

(51) Int. Cl. H02J 3/28; H05B 33/08

(52) U.S. Cl. CPC H02J 3/28; H05B 33/0812; H05B 33/0845

(57) ABSTRACT

The present invention discloses a light system with energy management function and control method thereof. The lighting system based on plastic forming technology. That is an application of energy storage module that balances the off-peak electricity to be used at noon. The principal merit is replacing the independent emergency lighting equipment attached at wall. By comparing these two systems, it is realized that the illumination and cost are much better than the traditional type of emergency lighting equipment due to the weathering quality of using plastic forming technology. Furthermore, this invention is much available be applied in outdoor.

### BACKGROUND OF THE INVENTION

1. Field of the Invention

This invention generally relates to a light system, and more particularly, to a light system with energy management function and control method thereof.

2. Description of the Prior Art

When the earthquake, fire, natural disaster or man-made disaster happens, it always has taken heavy casualties because people have caught unprepared and run away helter-skelter. More specifically, in the high building, the apartment and any public place, people further need to plan or prepare any fire-fighting equipment or emergency escaped equipment against a rainy day because it is difficult to escape.

When the general disaster happens, the electric always is broken. It seriously affects the path of running away. It is important to plan or prepare any fire-fighting equipment or emergency escaped equipment. Thereby, most of building or apartment always set the emergency light equipment so the inner offers can run away according to the guidance direction and light from the emergency light equipment when the of the fire, earthquake or other disasters come. Especially, the public place further need to be mounted the emergency light equipment.

The emergency light equipment means the equipment continuous to provide the light when the electrically supply is broken. The general emergency light equipment has the battery inside which is usually charged by the power supply. The battery will provide the electrical to the light unit so as to provide the light when detecting the power supply broken. Further, the purpose of the emergency light equipment is for keeping the minimum visibility of the home, work place, and refuge path so as to allow the people end the work in short time or guide the people to shelter in the emergency statue. One of the most common emergency light systems is the emergency lighting. The emergency lighting is usually mounted on the places whose people usual through to the refuge, for example, the hallways, stairs, paths or other place depend on the light. The emergency light equipment has the automatic switch device between AC and DC. The emergency light equipment usually uses the AC power to automatically charge the backup battery unit the saturation of the electrical. And the emergency light equipment switch to the backup battery to provide the electrical when the when the electricity fail.

For the reason that the conventional feed system needs to spend the mass cost and has many disadvantages, for example, the bad visibility and the easy damage the battery, and can not be used in the actual electrical network to adjust the electrical, a need has arisen to propose a novel scheme that may adaptively provide to improve the disadvantages of the conventional.

### SUMMARY OF THE INVENTION

In view of the foregoing, it is an object of the present invention to provide a light system with energy management function according to one embodiment of the present invention. The light system with energy management function comprises an AC device, inputting an input source; a rectifier, coupled to the AC device, rectifying the input source; a first filter, coupled to the rectifier, filtering the input source rectified; a voltage detector, coupled to the first filter; an anti-reverse, coupled to the voltage sensor; a first voltage adjusting module, coupled to the anti-reverse, adjusting the voltage of the light diode so as to use the input source to a specific voltage to enable the light diode; a second filter, coupled to first voltage adjusting module; an energy management module, coupled to the AC device and the voltage detector, obtaining a time information according a clock so as to perform the energy management according to the time information and generating a pulse width modulation signal; a half-bridge circuit, coupled to the energy management module, receiving the pulse width modulation (PWM) signal; and a battery, couple to the half-bridge circuit, storing or discharging the energy.

Perfectly, the light system with energy management function further comprises a first capacitor, coupled to the rectifier, wherein the voltage detector is used to detect the voltage of the first capacitor.

Perfectly, the half-bridge circuit further comprises a inductor and two MOSFETs, and in buck mode, the PWM signal is sent to drive upper the voltage of the MOSFET when the voltage of the first capacitor is stepped down to charge the battery, and the PWN signal is sent to drive lower the voltage of MOSFET when the voltage of battery is stepped up to power the LED up.

Perfectly, the light system with energy management function further comprises a second voltage detector, mounted between the half-bridge circuit and the battery to detect the voltage of the battery.

Perfectly, the energy management module further comprises: a voltage microprocessor control unit (MCU), coupled to the anti-reverse and the half-bridge circuit; a microprocessor control unit (MCU), coupled to the first voltage detector, the voltage microprocessor, the AC device and the second voltage detector, obtaining a time information according a clock so as to perform the energy management according to the time information and generating a pulse width modulation (PWM) signal; and a clock circuit, coupled to the MCU, generating the clock.

Perfectly, the AC device further comprises a switch and a transformer, and the transformer drops the AC down to low level, wherein the energy management module to detect the whether the switch enables.

Perfectly, the rectifier is bridge full wave rectifier and the battery is a lithium battery or an element used to store the energy.

Perfectly, the light system further comprises a housing which is manufactured by the plastic molding technology and the housing has a camber surface.

Based on the abovementioned objectives of the present invention, a control method of managing energy is disclosed. The method comprises: connecting to an AC device; charging a batter initially so as to enter a normal light; determining whether the voltage of battery larger than the charge voltage so as to enter an intelligent operation; enabling a switch in the AC device when entering the intelligent operation; determining whether the switch voltage is larger than the charge voltage so as to a peak hour; and determining whether the voltage of battery larger than the charge voltage again so as to discharge the battery and enter a save mode.

Perfectly, the step of determining whether the switch voltage is larger than the charge voltage so as to a peak hour further comprises: entering an intelligent operation when the voltage of switch is lower than the voltage of charge.

Perfectly, the method further comprises: whether the voltage of battery is larger than the voltage of charge when entering the intelligent operation; returning the intelligent operation if yes, otherwise, entering a no light.

Perfectly, the step of determining whether the voltage of battery larger than the charge voltage again, further comprises: entering the normal light when the voltage of battery is smaller than the voltage of discharge.

Based on the abovementioned objectives of the present invention, a light system with energy management function is disclosed according to one embodiment of the present invention. The light system with energy management function comprises: a light device; and an energy management module, coupled to the light device, obtaining a time information according a clock so as to perform the energy management according to the time information and generating a pulse width modulation signal.

Perfectly, the light system with energy management function further comprises: an AC device, inputting an input source; a rectifier, coupled to the AC device, rectifying the input source; a first filter, coupled to the rectifier, filtering the input source rectified; a voltage detector, coupled to the first filter; an anti-reverse, coupled to the voltage sensor; a first voltage adjusting module, coupled to the anti-reverse, adjusting the voltage of the light diode so as to use the input source to a specific voltage to enable the light diode; a second filter, coupled to first voltage adjusting module; a half-bridge circuit, coupled to the energy management module, receiving the pulse width modulation (PWM) signal; and a battery, couple to the half-bridge circuit, storing or discharging the energy.

Perfectly, the light system with energy management function further comprises: a second voltage detector, mounted between the half-bridge circuit and the battery to detect the voltage of the battery.

Perfectly, the energy management module further comprises: a voltage microprocessor control unit (MCU), coupled to the anti-reverse and the half-bridge circuit; a microprocessor control unit (MCU), coupled to the first voltage detector, the voltage microprocessor, the AC device and the second voltage detector, obtaining a time information according a clock so as to perform the energy management according to the time information and generating a pulse width modulation (PWM) signal; and a clock circuit, coupled to the MCU, generating the clock.

Perfectly, the light system with energy management function further comprises: a first capacitor, coupled to the rectifier, wherein the voltage detector is used to detect the voltage of the first capacitor; wherein the half-bridge circuit further comprises a inductor and two MOSFETs, and in buck mode, the PWM signal is sent to drive upper the voltage of the MOSFET when the voltage of the first capacitor is stepped down to charge the battery, and the PWN signal is sent to drive lower the voltage of MOSFET when the voltage of battery is stepped up to power the LED up.

### BRIEF DESCRIPTION OF THE DRAWINGS

The accompanying drawings incorporated in and forming a part of the specification illustrate several aspects of the present invention, and together with the description serve to explain the principles of the disclosure. In the drawings:

FIG. 1 shows a light system with energy management function according to one embodiment of present invention;

FIG. 2A shows a schematic diagram of a general charge mode and current flow direction thereof according to one embodiment of present invention;

FIG. 2B shows a schematic diagram of an emergency mode and current flow direction thereof according to one embodiment of present invention.

FIG. 2C shows a schematic diagram of an night discharge mode and current flow direction thereof;

FIG. 3 shows a schematic diagram of a control method of managing energy according to one embodiment of present invention; and

FIG. 4 shows a diagram of a battery voltage variable with control time.

### DETAILED DESCRIPTION OF THE PREFERRED EMBODIMENTS

Some embodiments of the present invention will now be described in greater detail. Nevertheless, it should be noted that the present invention can be practiced in a wide range of other embodiments besides those explicitly described, and the scope of the present invention is expressly not limited except as specified in the accompanying claims.

Moreover, some irrelevant details are not drawn in order to make the illustrations concise and to provide a clear description for easily understanding the present invention.

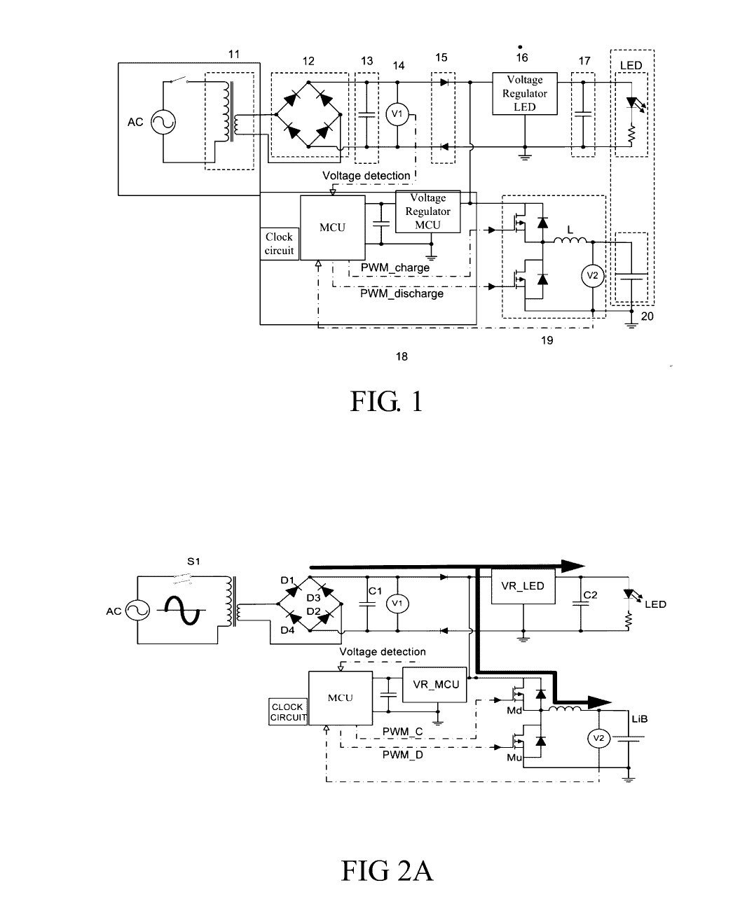

Referring to FIG. 1, which illustrates a light system with energy management function according to one embodiment of present invention, comprising: an AC device 11, a rectifier 12, a first filter 13, a voltage detector 14, an anti-reverse 15, a first voltage adjusting module 16, a second filter 17, an energy management module 18, a half-bridge circuit 19 and a battery 20.

The AC device 11 is used for inputting an input source. The rectifier 12 is coupled to the AC device 11 for rectifying the input source. The first filter 13 is coupled to the rectifier for filtering the input source rectified. The voltage detector 14 is coupled to the first filter 13. The anti-reverse 15 is coupled to the voltage sensor 14. The first voltage adjusting module 16 is coupled to the anti-reverse 14 for adjusting the voltage of the light diode so as to use the input source to a specific voltage to enable the light diode. The second filter 17 is coupled to first voltage adjusting module 16. The energy management module 18 is coupled to the AC device 11 and the voltage detector 14 for obtaining a time information according a clock so as to perform the energy management according to the time information and generating a pulse width modulation signal. The half-bridge circuit 19 is coupled to the energy management module 18 for receiving the pulse width modulation (PWM) signal and the battery 20 is couple to the half-bridge circuit 19 for storing or discharging the energy.

The first filter 13 in the first light system with energy management function further comprises: a first capacitor C1, which is coupled to the rectifier 12, wherein the voltage detector 14 is used to detect the voltage of the first capacitor C1. The half-circuit 19 further comprises a inductor L and two MOSFETs, Md, Mu, and in buck mode, the PWM signal is sent to drive upper the voltage of the MOSFET when the voltage of the first capacitor C1 is stepped down to charge the battery LiB, and the PWN signal is sent to drive lower the voltage of MOSFET when the voltage of battery LiB is stepped up to power the LED up. The second voltage detector C2 is mounted between the half-bridge circuit 19 and the battery 20 to detect the voltage of the battery 20.

The energy management module 18 further comprises: a voltage microprocessor control unit (MCU), which is coupled to the anti-reverse and the half-bridge circuit; a microprocessor control unit (MCU), which is coupled to the first voltage detector, the voltage microprocessor, the AC device and the second voltage detector for obtaining a time information according a clock so as to perform the energy management according to the time information and generating a pulse width modulation (PWM) signal; and a clock circuit, which is coupled to the MCU for generating the clock.

The rectifier 12 is bridge full wave rectifier and the battery 20 is a lithium battery or an element used to store the energy. However, the battery disclosed is not limited in the description of the embodiment. The skill art usually know many kinds of batteries, and therefore, the elements used to store the energy all apply in the embodiment, for example, the super capacitor or nickel battery.

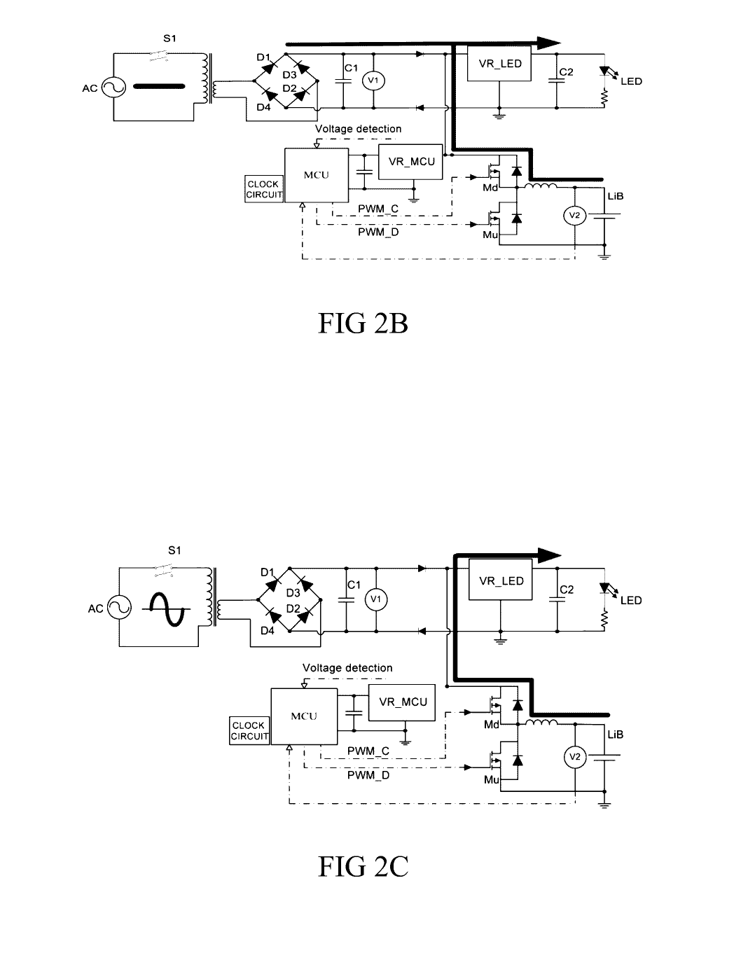

In the embodiment, the light system with energy management function of present invention has three modes: one is a general charge mode and the current flow direction thereof is shown in FIG. 2A; another is an emergency mode and current flow direction thereof is shown in FIG. 2B; the other is an night discharge mode and current flow direction thereof is shown FIG. 2C.

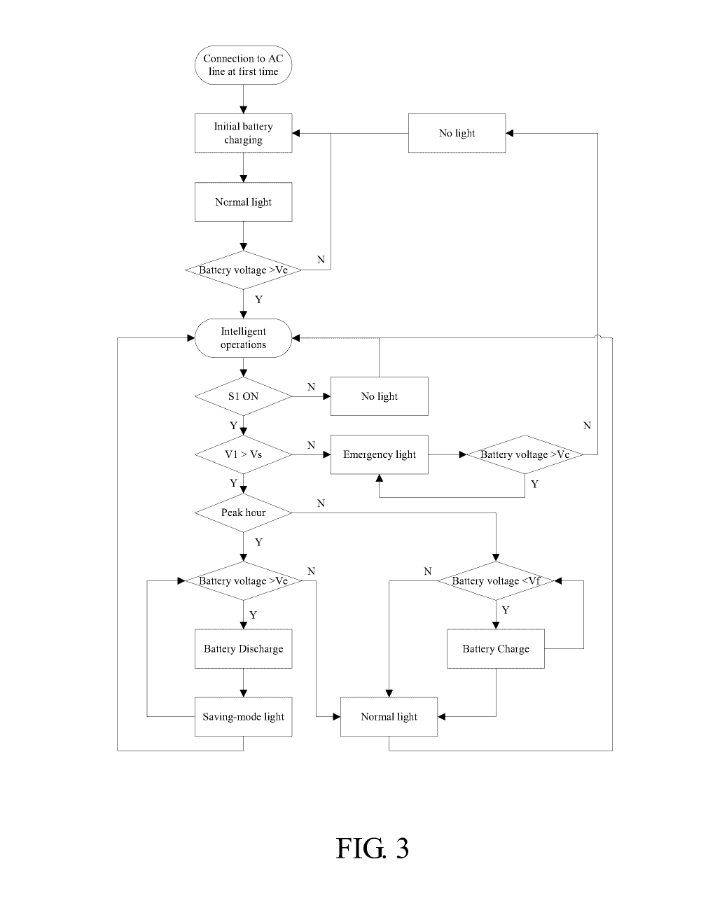

Referring to FIG. 3, which illustrates a control method of managing energy according to one embodiment of present invention. The method comprises: connecting to an AC device (s301); charging a batter initially so as to enter a normal light (s302, s303); determining whether the voltage of battery larger than the charge voltage so as to enter an intelligent operation (s304, s305); enabling a switch in the AC device when entering the intelligent operation(s306); determining whether the switch voltage is larger than the charge voltage so as to a peak hour (s307, s308); and determining whether the voltage of battery larger than the charge voltage again so as to discharge the battery and enter a save mode (s309,s310, s311).

Specifically, the step of determining whether the switch voltage is larger than the charge voltage so as to a peak hour further comprises: entering an intelligent operation when the voltage of switch is lower than the voltage of charge. Specifically, whether the voltage of battery is larger than the voltage of charge when entering the intelligent operation; returning the intelligent operation if yes, otherwise, entering a no light. Specifically, wherein the step of determining whether the voltage of battery larger than the charge voltage again, further comprises: entering the normal light when the voltage of battery is smaller than the voltage of discharge.

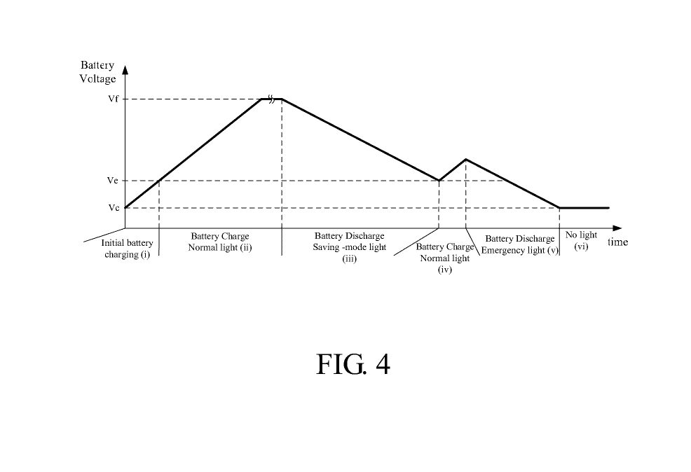

Referring to FIG. 4, which illustrates a diagram of a battery voltage variable with control time. As shown in FIG. 4, at initial battery charging (i), when the invented device of the present invention is connected to line at first time or finished emergency light mission, lithium battery is required to be charged to voltage higher than Ve as shown in the initial battery charging (i). As shown in FIG. 4, Vc is the cut-off voltage that the battery shall be kept above to avoid the damage. Ve is the voltage in which the battery can sustain to power LED up for at least 30 min. until the voltage drops down to Vc. Vf is the voltage in which the battery is charged fully. In initial battery charging, it is transited to intelligent operations once Ve is reached. During this operation, AC line power LED up and MCU drive half-bridge converter in buck mode to charge the battery (LiB) as shown in FIG. 4. In the embodiment, the intelligent operation means the invented system operates in this permanent loop once initial battery charging is completed. The only exception is when emergency light mode is conducted and Vc is reached.

In battery charge normal light (ii), initially, the LED power is delivered from AC line. As shown in FIG. 4, the battery voltage is charged from Ve to Vf in this mode.

In the battery discharge saving-mode light (iii), in peak hour, the battery replaces AC line to power LED up for consuming cheap electricity acquired from non-peak hour as shown in FIG. 4. To achieve this, the boosted voltage shall little higher than C1 to keep Dp and Dn reverse-biased. The battery voltage is decreased from Vf to Ve as shown in FIG. 4 such that the invented device can always perform emergency light service over 30 min. at any moment. The charge stored from Ve to Vf can be computed or conducting saving-mode service over all non-peak hour time.

In battery discharge normal light (iv), in intelligent operation, this mode as illustrated in FIG. 4. The AC line power LED up and charge the battery at the same time. To achieve this, half-bridge circuit is operated in buck mode as shown in FIG. 4.

In battery discharge emergency light (iv), when switch S1 is kept ON status yet AC line power is shortage, MCU sensed S1 is ON and voltage V1 is lower than Vs so as to operate half-bridge circuit in boost mode to power LED as shown in FIG. 4. This mode is finished when the battery voltage is lower than Vc by seeing FIG. 1 MCU is also shut down.

In no light mode (vi), when switch S1 is manually switched OFF, there is no necessary to power LED up. MCU sensed S1 is OFF so as to stop sending PWM signals to half-bridge circuit. In other case, it is also the mode when emergency light mode comes to an end by seeing FIG. 4.

The present invention comprises the LED light circuit, the lithium battery and the shell forming the plastic technology. Specifically, the LED light circuit comprises the energy management module receives the electrical power to storage in the battery so as to provide the light when the night discharge or the electricity fails. The LED light circuit comprises the switch circuit of emergency source and the general discharge. The LED light circuit further comprises the rectification circuit and the shell forming the plastic technology with the high hardness and high decay resistance. The lamp size described in the present invention is equal with the commercial lamp, and therefore, it can be replaced with the independent wall-mounted emergency source used in general emergency status, and therefore, the consumer only replace one or the part general lamps with the lamp described in the present invention so as to achieve the requirement of the present invention. Moreover, the surface design of the present invention can provide the excellent even lighting without glare and better than other glass lamps. Specifically, the device of present invention is mounted in the general light point so can provide the light being equal the general light. Therefore, the device of present invention may remain the mental state of people when the disaster happens or the electrical fails so as to easy to verify the refuge direction and increase the survival chance.

The system or product of the present invention can be replaced with the independent wall-mounted emergency source used in general emergency status, and therefore, the consumer only replace one or the part general lamps with the lamp described in the present invention so as to achieve the requirement of fire code. Moreover, the surface design of the present invention can provide the excellent even lighting without glare and better than other glass lamps.

The system or product of the present invention can provide the light being equal the general light. Therefore, the device of present invention may remain the mental state of people when the disaster happens or the electrical fails so as to easy to verify the refuge direction and increase the survival chance. The conventional technology may not have the advantage of the present invention.

From the point of economy, the LED industry of Taiwan is limited to China because of the lower cost. How to combine the present technologies of Taiwan to perform the product development so as to show the different with the convention product and develop the market. This is top priority. Therefore, the present invention combines the LED technology with shell forming plastic technology with the high hardness and high decay resistance and the element used to store energy, for example, the lithium battery, super capacitor, nickel batter, etc. Further, the present invention combines the LED light products with the energy management module of the present invention so as to replace with conventional independent emergency light system and develop the market.

Although most conventional products apply the LED to perform the light function, it is difficult to earn the high profits or develop the product with high value. However, the product of prevent invention man solve the disadvantage of the conventional product, for example, high cost, the bad visibility and the easy damage the battery, and can not be used in the actual electrical network to adjust the electrical. Even the product of present invention can save the cost, not need to buy additional device or based independent circuit, and is easy to be accepted by the market. The present invention also can be used in the car light technology because the shell of the present invention forming the plastic technology with the high hardness and high decay resistance, and can provide the excellent even lighting without glare and better than other glass lamps.

The present invention comprises the LED light circuit, and we invent a LED lighting system with energy management system based on plastic forming technology. That is an application of energy storage module that balances the off-peak electricity to be used at noon. The principal merit is replacing the independent emergency lighting equipment attached at wall. By comparing these two systems, it is realized that the illumination and cost are much better than the traditional type of emergency lighting equipment due to the weathering quality of using plastic forming technology. Furthermore, this invention is much available be applied in outdoor.

For the reason that the conventional feed system needs to spend the mass cost and has many disadvantages, for example, the bad visibility and the easy damage the battery, and can not be used in the actual electrical network to adjust the electrical, a need has arisen to propose a novel scheme that may adaptively provide to improve the disadvantages of the conventional. And the present invention combines the lithium battery with the LED light system and performs the electrical balance between the peak hour and off-peak hour in the light system via the energy management module. Moreover, the lamp size used in the present invention is equal with the general lamp, and therefore, it is easy to replace with the general lamp.

Although specific embodiments have been illustrated and described, it will be obvious to those skilled in the art that various modifications may be made without departing from what is intended to be limited solely by the appended claims.

What is claimed is:

1. A light system with energy management function, comprising:
an AC device, inputting an input source;
a rectifier, coupled to the AC device, rectifying the input source;
a first filter, coupled to the rectifier, filtering the input source rectified;
a voltage detector, coupled to the first filter;
an anti-reverse, coupled to the voltage sensor;
a first voltage adjusting module, coupled to the anti-reverse, adjusting the voltage of the light diode so as to use the input source to a specific voltage to enable the light diode;
a second filter, coupled to first voltage adjusting module;
an energy management module, coupled to the AC device and the voltage detector, obtaining a time information according a clock so as to perform the energy management according to the time information and generating a pulse width modulation signal;
a half-bridge circuit, coupled to the energy management module, receiving the pulse width modulation (PWM) signal; and
a battery, couple to the half-bridge circuit, storing or discharging the energy.

2. The light system with energy management function according to claim 1, further comprising:
a first capacitor, coupled to the rectifier, wherein the voltage detector is used to detect the voltage of the first capacitor.

3. The light system with energy management function according to claim 2, wherein the half-bridge circuit further comprises a inductor and two MOSFETs, and in buck mode, the PWM signal is sent to drive upper the voltage of the MOSFET when the voltage of the first capacitor is stepped down to charge the battery, and the PWN signal is sent to drive lower the voltage of MOSFET when the voltage of battery is stepped up to power the LED up.

4. The light system with energy management function according to claim 1, comprising:
a second voltage detector, mounted between the half-bridge circuit and the battery to detect the voltage of the battery.

5. The light system with energy management function according to claim 4, wherein the energy management module further comprises:
a voltage microprocessor control unit (MCU), coupled to the anti-reverse and the half-bridge circuit;
a microprocessor control unit (MCU), coupled to the first voltage detector, the voltage microprocessor, the AC device and the second voltage detector, obtaining a time information according a clock so as to perform the energy management according to the time information and generating a pulse width modulation (PWM) signal; and
a clock circuit, coupled to the MCU, generating the clock.

6. The light system with energy management function according to claim 1, wherein the AC device further comprises a switch and a transformer, and the transformer drops the AC down to low level, wherein the energy management module to detect the whether the switch enables.

7. The light system with energy management function according to claim 1, wherein the rectifier is bridge full wave rectifier and the battery is a lithium battery or an element used to store the energy.

8. The light system with energy management function according to claim 1, wherein the light system further comprises a housing which is manufactured by the plastic molding technology and the housing has a camber surface.

9. A control method of managing energy, comprising:
connecting to an AC device;
charging a batter initially so as to enter a normal light;
determining whether the voltage of battery larger than the charge voltage so as to enter an intelligent operation;
enabling a switch in the AC device when entering the intelligent operation;
determining whether the switch voltage is larger than the charge voltage so as to a peak hour; and
determining whether the voltage of battery larger than the charge voltage again so as to discharge the battery and enter a save mode.

10. The control method according to claim 9, wherein the step of determining whether the switch voltage is larger than the charge voltage so as to a peak hour further comprises:
entering an intelligent operation when the voltage of switch is lower than the voltage of charge.

11. The control method according to claim 9, further comprising:
whether the voltage of battery is larger than the voltage of charge when entering the intelligent operation;
returning the intelligent operation if yes, otherwise, entering a no light.

12. The control method according to claim 9, wherein the step of determining whether the voltage of battery larger than the charge voltage again, further comprises:
entering the normal light when the voltage of battery is smaller than the voltage of discharge.

13. A light system with energy management function, comprising:
a light device; and
an energy management module, coupled to the light device, obtaining a time information according a clock so as to perform the energy management according to the time information and generating a pulse width modulation signal.

14. The light system with energy management function according to claim 13, further comprising:
an AC device, inputting an input source;
a rectifier, coupled to the AC device, rectifying the input source;
a first filter, coupled to the rectifier, filtering the input source rectified;
a voltage detector, coupled to the first filter;
an anti-reverse, coupled to the voltage sensor;
a first voltage adjusting module, coupled to the anti-reverse, adjusting the voltage of the light diode so as to use the input source to a specific voltage to enable the light diode;
a second filter, coupled to first voltage adjusting module;
a half-bridge circuit, coupled to the energy management module, receiving the pulse width modulation (PWM) signal; and
a battery, couple to the half-bridge circuit, storing or discharging the energy.

15. The light system with energy management function according to claim 13, further comprising:
a second voltage detector, mounted between the half-bridge circuit and the battery to detect the voltage of the battery.

16. The light system with energy management function according to claim 15, wherein the energy management module further comprises:
a voltage microprocessor control unit (MCU), coupled to the anti-reverse and the half-bridge circuit;
a microprocessor control unit (MCU), coupled to the first voltage detector, the voltage microprocessor, the AC device and the second voltage detector, obtaining a time information according a clock so as to perform the energy management according to the time information and generating a pulse width modulation (PWM) signal; and
a clock circuit, coupled to the MCU, generating the clock.

17. The light system with energy management function according to claim 15, further comprising:
a first capacitor, coupled to the rectifier, wherein the voltage detector is used to detect the voltage of the first capacitor;
wherein the half-bridge circuit further comprises a inductor and two MOSFETs, and in buck mode, the PWM signal is sent to drive upper the voltage of the MOSFET when the voltage of the first capacitor is stepped down to charge the battery, and the PWN signal is sent to drive lower the voltage of MOSFET when the voltage of battery is stepped up to power the LED up.
